(19) United States
(12) Patent Application Publication
(10) Pub. No.: US 2014/0160122 A1
(43) Pub. Date: Jun. 12, 2014

(54) CREATING A VIRTUAL REPRESENTATION BASED ON CAMERA DATA

(71) Applicant: MICROSOFT CORPORATION, Redmond, WA (US)

(72) Inventor: Philip Andrew Chou, Bellevue, WA (US)

(73) Assignee: MICROSOFT CORPORATION, Redmond, WA (US)

(21) Appl. No.: 13/709,846

(22) Filed: Dec. 10, 2012

(51) Int. Cl. G06T 13/20; G06T 17/00

(52) U.S. Cl. CPC G06T 13/20; G06T 17/00
USPC 345/420

(57) ABSTRACT

Some implementations may include a computing device to generate a three dimensional representation of an object. The computing device may receive data associated with an object that is within a view of a camera. The computing device may determine occluded portions of the object that are occluded from the view of the camera. The computing device may determine extrapolated data corresponding to the occluded portions of the object. The computing device may generate a representation corresponding to the object based on the data and the extrapolated data. The representation may include a mesh and a set of bones, where each bone of the set of bones is attached to a vertex of a polygon of the mesh.

### BACKGROUND

Some types of applications, such as gaming and immersive teleconferencing, may create a virtual world that includes representations of one or more participants. However, the representations may be based on predetermined models that do not accurately portray the characteristics (e.g., physical appearance and movements) of the participants.

### SUMMARY

This Summary is provided to introduce a selection of concepts in a simplified form that are further described below in the Detailed Description. This Summary is not intended to identify key or essential features of the claimed subject matter; nor is it to be used for determining or limiting the scope of the claimed subject matter.

Some implementations disclosed herein provide techniques and arrangements to generate a three dimensional representation of an object. The computing device may receive data associated with an object that is within a view of a camera. The computing device may determine portions of the object that are occluded from the view of the camera. The computing device may determine extrapolated data corresponding to the occluded portions of the object. The computing device may generate a representation corresponding to the object based on the data and the extrapolated data. The representation may include a mesh and a set of bones, where each bone of the set of bones is attached to a vertex of a polygon of the mesh. Additional data received from the camera may include information associated with at least one of the occluded portions of the object. The computing device may re-generate the representation based on the additional data.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is an illustrative architecture that includes creating virtual representations corresponding to participants based on camera data according to some implementations.

FIG. 2 is an illustrative architecture that includes creating a virtual representation using a skinned rig model according to some implementations.

FIG. 3 is an illustrative architecture that includes creating virtual representations based on camera data received over a period of time according to some implementations.

FIG. 4 is an illustrative architecture that includes identifying vertices of a representation that correspond to pixels of an object captured in a frame according to some implementations.

FIG. 5 is a flow diagram of an example process that includes identifying vertices in a rigging that correspond to pixels in a frame according to some implementations.

FIG. 6 is a flow diagram of an example process that includes generating a representation corresponding to an object according to some implementations.

FIG. 7 is a flow diagram of an example process that includes generating a first representation of an object in a first pose according to some implementations.

FIG. 8 is a flow diagram of an example process that includes receiving data associated with an object that is within a view of a camera according to some implementations.

FIG. 9 illustrates an example configuration of a computing device and environment that can be used to implement the modules and functions described herein

### DETAILED DESCRIPTION

The systems and techniques described herein may be used create virtual representations (“representations”) of animate objects (e.g., people) and inanimate objects using camera data from a camera. For example, a camera that provides color (e.g., red, green, and blue (RGB)) data as well as depth data (e.g., a distance of each pixel from the camera) may be used to provide the camera data.

The camera data may be used by a software program to generate a virtual representation (also referred to as a representation). For example, one or more cameras may capture data associated with movements of a person and provide the data to the software program. Based on the data, the software program may create a representation (e.g., in a virtual world) that corresponds to the person. The representation may be in the form of an animation model, such as a skinned rig model, that enables the representation to be animated in a way that movements of the representation correspond to movements of the person.

As the person moves over a period of time, the software program may refine the representation based on the data received over the period of time such that a current representation more accurately portrays the person as compared to a previous representation. In other words, a difference between the characteristics of the person and the characteristics of the corresponding representation may be reduced over the period of time. For example, initially, portions of the person's body may be occluded (or otherwise not visible) to the one or more cameras. Over the period of time, the person may rotate at least a portion of the person's body, enabling the camera to capture additional data that includes portions of the person's body that were previously occluded. The software program may refine the representation based on the additional data that was captured such that the characteristics (e.g., size, shape, etc.) of the representation more closely correspond to the characteristics of the person. For example, initially, the person may face the camera. The software application may receive initial data from the camera, extrapolate certain characteristics (e.g., height, depth, etc.) associated with the person based on the initial data, and generate a representation based on the initial data and the extrapolated characteristics. For example, the extrapolation may be based on a generic human model. Over the period of time, the person may perform various movements (e.g., stand up, sit down, turn, rotate, tilt, or the like), enabling the camera to capture additional data of portions of the person's body that were previously occluded. The software program may generate a new representation corresponding to the person head based on the additional data such that the new representation (e.g., at a time t(m) where m>0) is more accurate compared to a previously generated representation (e.g., at a time t(0)).

Thus, one or more cameras may be used to capture an object, such as a person. The cameras may provide data that includes color data (e.g., RGB data) and depth data. A software program may receive the data and generate a representation of the object in a virtual world. The cameras may provide data that includes frames capturing one or more views of the person. The data may be provided at a fixed frame rate (e.g., 10 frames per second (fps), 15 fps, 30 fps, 60 fps, or the like). As the person moves, portions of the person that were previously occluded may come into the field of view of the cameras, enabling the cameras to capture additional data associated with the previously occluded portions of the person. The software program may use the additional data to generate a new representation of the person that more accurately represents the person compared to a previous representation that was generated prior to receiving the additional data.

### Illustrative Architectures

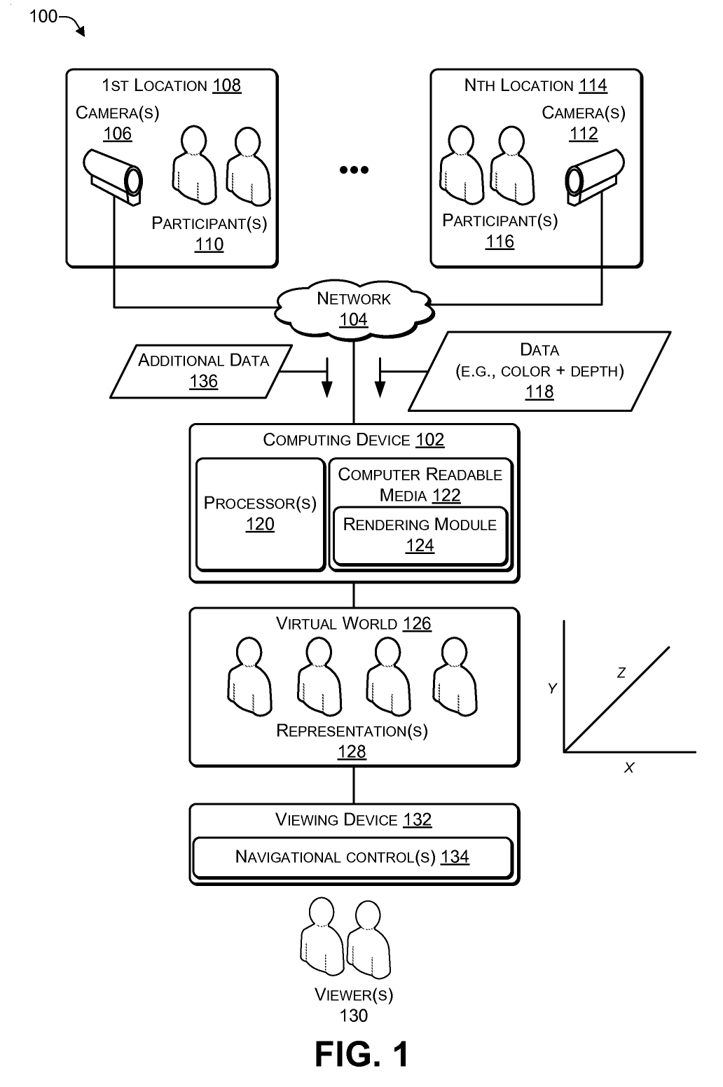

FIG. 1 is an illustrative architecture 100 that includes creating virtual representations corresponding to participants based on camera data according to some implementations. The architecture 100 includes a computing device 102 coupled to a network 104. The network 106 may include one or more networks, such as a wireless local area network (e.g., WiFi®, Bluetooth™, or other type of near-field communication (NFC) network), a wireless wide area network (e.g., a code division multiple access (CDMA), a global system for mobile (GSM) network, or a long term evolution (LTE) network), a wired network (e.g., Ethernet, data over cable service interface specification (DOCSIS), Fiber Optic System (FiOS), Digital Subscriber Line (DSL) and the like), other type of network, or any combination thereof.

One or more cameras located at one or more locations may be used to capture one or more participants at each location. For example, as illustrated in FIG. 1, one or cameras 106 may be located at a first location 108 to capture one or more participants 110. In some cases, one or more cameras 112 may be located at an additional N−1 locations, up to and including an Nth location 114 (where N>1) to capture one or more participants 116. Each of the cameras 106, 112 may capture frames of a scene at a rate of F fps (where F>0). Each frame may be captured and transmitted in the form of data 118. The data 118 may include color data (e.g., RGB data) and depth data. The color data may indicate a color of each pixel captured in a frame while the depth data may include a distance of each pixel captured in the frame relative to the position of each camera. In some implementations, each camera may include a first camera to capture color data, a second camera to capture depth data, and one or more of software, firmware, or hardware to combine the color data and the depth data to create the data 118 for transmission to the computing device 102. In some cases, at least some of the cameras 106, 112 may be stationary. In other cases, at least some of the cameras 106, 112 may be moveable. For example, some of the cameras 106, 112 may automatically sweep back and forth at a predetermined rate. As another example, some of the cameras 106, 112 may move from a first position to a second position in response to a command sent by a user (e.g., a participant or a viewer).

The computing device 102 may include one or more processors 120 and computer readable media 122 (e.g., memory). The computer readable media 122 may be used to store software, including an operating system, device drivers, and software applications. The software applications may include modules to perform various functions, including a rendering module 124 to render a virtual world 126. The virtual world 126 may include one or more representations 128, with each of the representations 128 corresponding to one of the participants 110, 116. The computing device 102 may also include one or more network interfaces to access other devices (e.g., the cameras 106, 112) using the network 104.

One or more viewers 130 may view the virtual world 126 using a viewing device 132. The viewers 130 may be individuals who are viewing the virtual world 126. The viewing device 132 may include one or more processors, computer readable media, a display device, a pair of goggles, other types of hardware, or any combination thereof. For example, the viewing device 132 may be a portable computing device, such as a tablet computing device, a wireless phone, a media playback device, or another type of device capable of displaying views of a virtual world. The viewing device 132 may provide a two-dimensional or three-dimensional view of the virtual world. The viewing device 132 may include navigational controls 134 (e.g., a joystick, an accelerometer, and the like) to enable the viewers 130 to navigate (e.g., up to 360 degrees in each of the x-axis, y-axis, and z-axis) the virtual world 126 to view different perspectives of the virtual world 126. For example, the viewers 130 may use the navigational controls 134 to move around (e.g., circumnavigate) one or more of the representations 128 in the virtual world 126. To illustrate, the viewing device 132 may be a portable computing device, such as a tablet computing device or a wireless phone. In this illustration, the viewers 130 may view the virtual world 126 on a display device associated with the viewing device 132 and may navigate the virtual world 126 by moving (e.g., tilting, rotating, etc.) the viewing device 132. The viewing device 132 may determine an amount of the movement along each of the x-axis, y-axis, and z-axis using sensors (e.g., accelerometers and/or other motion-detecting sensors) built-in to the viewing device 132. The viewing device 132 may alter a view (e.g., perspective) of the virtual world 126 that is displayed on the viewing device 132 in response to the movement (e.g., navigational input) provided by the viewers 130.

While a single viewing device is illustrated in FIG. 1, in some embodiments at least some of the viewers 130 may each have their own viewing device to enable each of the viewers 130 to have an interaction with the virtual world 126 that is different relative to others from the viewers 130. For example, a first viewer may interact with a first and a second participant while a second viewer interacts with a third and a fourth participant. As another example, a first viewer and a second viewer may interact with a first participant and a second participant while a third viewer interacts with the second participant and a third participant. In addition, in some cases, at least some of the participants 110, 116 may include the viewers 130, at least some of the viewers 130 may include the participants 110, 116, etc. For example, a first group of individuals may be participants, a second group of individuals may be viewers, and a third group of individuals may be both participants and viewers. To illustrate, the individuals in the third group may be located at locations with cameras and may each have viewing devices.

Thus, the representations 128 in the virtual world 126 may include three-dimensional reconstructions of the participants 110, 116. The viewing device 132 may be used to provide novel views, e.g., views of the participants 110, 116 that are not captured by (e.g., occluded from) the cameras 106, 112. For example, using the viewing device 132, the viewers 130 may see views of the representations 128 that are extrapolated based on the data 118 received from the cameras 106, 112. To illustrate, the computing device 102 may extrapolate portions of the representations 128 that correspond to portions of the participants 110, 116 that are occluded from the view of the cameras 106, 112. For example, the computing device 102 may automatically (e.g., without human interaction) determine a type of an object captured in the data 118, select a predetermined (e.g., generic or standard) representation based on the type of the object, and generate a representation by modifying the predetermined representation based on the data 118. If the computing device 102 is unable to determine the type of the object captured in the data 118, the computing device 102 may prompt one of the participants 110, 116 to identify the type of the object. For example, the computing device 102 may automatically determine a type of the participants 110, 116, e.g., determine that the participants 110, 116 are human beings and select a predetermined human representation. Thus, as the computing device 102 receives the data 118 and the additional data 136 over time, the computing device 102 may re-generate the representation based on the data 118 and the additional data 136 received from the cameras 106, 112 to further refine the representation. Over time, the computing device 102 may reduce a difference between a representation and a corresponding participant.

The computing device 102 may receive data (e.g., the data 118) from each of the cameras 106, 112 over a period of time (e.g., starting at time t(0) and ending at a time t(m)). The computing device 102 may periodically (e.g., at regular intervals) or in response to a particular event occurring (e.g., receiving the data), re-generate (e.g., determine) one or more of the representations 128 based on a latest of the data 118 that is received. Thus, over the period of time, one or more of the representations 128 may be recalculated to more accurately portray one or more of the participants 110, 116 as compared to the representations 128 calculated at a previous time during the time period. For example, initially (e.g., at the time t(0)), portions of a particular participant of the participants 110, 116 may be occluded (e.g., not visible) to the one or more of the cameras 106, 112. Over the period of time, the particular participant may move (e.g., rotate, get up, sit down, bend over, and the like), enabling one or more of the cameras 106, 112 to capture additional data 136. The additional data 136 may include data associated with previously occluded portions of the particular participant. The computing device 102 may refine one of the representations 128 corresponding to the particular participant based on the additional data 136. For example, initially, the person may face the camera. At a later point in time, the particular participant may move, enabling one or more of the cameras 106, 112 to capture the additional data 136. In this example, the additional data 136 may include data associated with portions of the particular participant that were previously occluded or otherwise not within the view of one or more of the cameras 106, 112. The computing device 102 may generate a new representation (e.g., of the representations 128) that corresponds to the particular participant based on the additional data 136, resulting in the new representation more accurately portraying the particular participant as compared to a previously generated representation. For example, a current difference between a participant (e.g., one of the participants 110, 116) and a corresponding representation generated in response to receiving the additional data 136 at time t(j) may be less than a previous difference between the participant and a previous representation generated at time t(i), where i<j. Thus, the computing device 102 may continually refine one or more of the representations 128 based on the additional data 136 received from one or more of the cameras 106, 112 to reduce a difference between the characteristics of the representations 128 and the characteristics (e.g., size etc.) of the corresponding participant.

The computer readable media 122 is an example of storage media used to store instructions which are executed by the processor(s) 120 to perform the various functions described above. For example, the computer readable media 122 may generally include both volatile memory and non-volatile memory (e.g., RAM, ROM, or the like). Further, the computer readable media 122 may include hard disk drives, solid-state drives, removable media, including external and removable drives, memory cards, flash memory, floppy disks, optical disks (e.g., CD, DVD), a storage array, a network attached storage, a storage area network, or the like. The computer readable media 122 may be one or more types of storage media capable of storing computer-readable, processor-executable program instructions as computer program code that can be executed by the processor(s) 120 as a particular machine configured for carrying out the operations and functions described in the implementations herein.

Computer storage media includes volatile and non-volatile, removable and non-removable media implemented in any method or technology for storage of information, such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device.

The computing device 102 may also include one or more communication interfaces for exchanging data with other devices, such as via a network, direct connection, or the like, as discussed above. The communication interfaces may facilitate communications within a wide variety of networks and protocol types, including wired networks (e.g., LAN, cable, etc.) and wireless networks (e.g., WLAN, cellular, satellite, etc.), the Internet and the like. The communication interfaces may also provide communication with external storage (not shown), such as in a storage array, network attached storage, storage area network, or the like.

The example systems and computing devices described herein are merely examples suitable for some implementations and are not intended to suggest any limitation as to the scope of use or functionality of the environments, architectures and frameworks that can implement the processes, components and features described herein. Thus, implementations herein are operational with numerous environments or architectures, and may be implemented in general purpose and special-purpose computing systems, or other devices having processing capability. Generally, any of the functions described with reference to the figures can be implemented using software, hardware (e.g., fixed logic circuitry) or a combination of these implementations. The term “module,” “mechanism” or “component” as used herein generally represents software, hardware, or a combination of software and hardware that can be configured to implement prescribed functions. For instance, in the case of a software implementation, the term “module,” “mechanism” or “component” can represent program code (and/or declarative-type instructions) that performs specified tasks or operations when executed on a processing device or devices (e.g., CPUs or processors). The program code can be stored in one or more computer-readable memory devices or other computer storage devices. Thus, the processes, components and modules described herein may be implemented by a computer program product.

Furthermore, this disclosure provides various example implementations, as described and as illustrated in the drawings. However, this disclosure is not limited to the implementations described and illustrated herein, but can extend to other implementations, as would be known or as would become known to those skilled in the art. Reference in the specification to “one implementation,” “this implementation,” “these implementations” or “some implementations” means that a particular feature, structure, or characteristic described is included in at least one implementation, and the appearances of these phrases in various places in the specification are not necessarily all referring to the same implementation.

Furthermore, while FIG. 1 sets forth an example of a suitable architecture to generate virtual representations based on camera data, numerous other possible architectures, frameworks, systems and environments will be apparent to those of skill in the art in view of the disclosure herein.

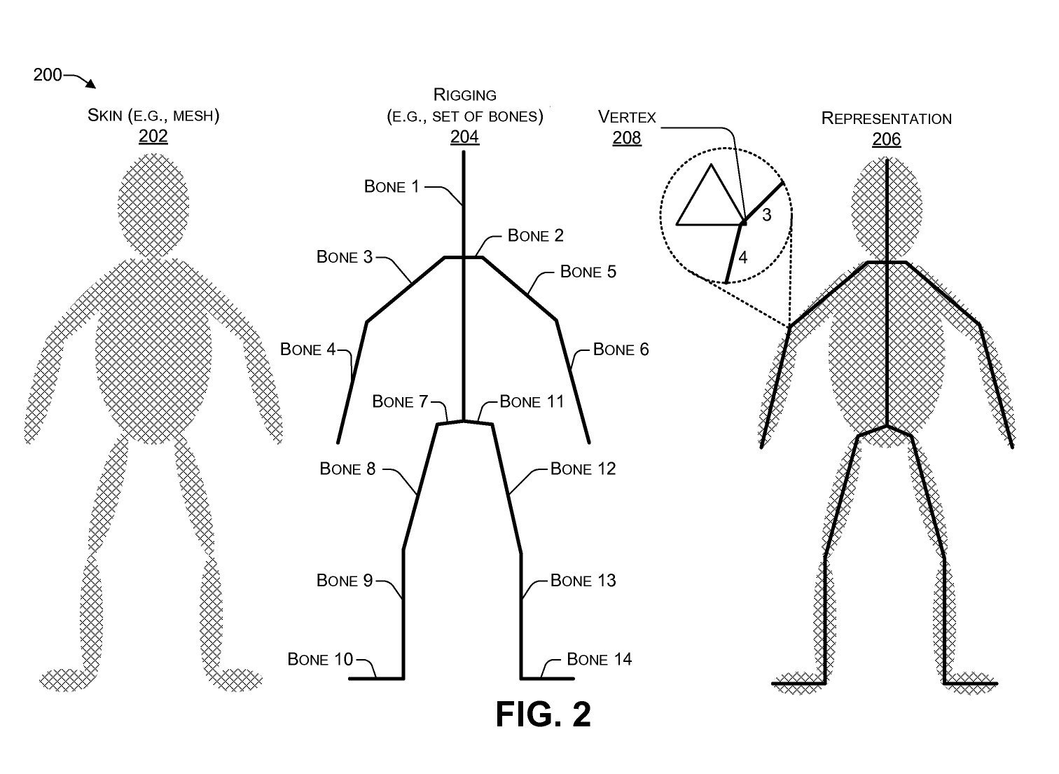

FIG. 2 is an illustrative architecture 200 that includes creating a virtual representation using a skinned rig model according to some implementations. The architecture illustrates how a representation (e.g., one of the representations 128) corresponding to a participant (e.g., one of the participants 110, 116) may be generated using a skinned rig model. The skinned rig model may be generated based on data received from one or more cameras (e.g., the cameras 106, 112 of FIG. 1).

A skinned rig model is a representation (e.g., one of the representations 128) of an object, such as one or more of the participants 110, 116 of FIG. 1. In a skinned rig model, an object may be represented using at least three parts: (1) a skin 202 (also referred to as a mesh) that is used to represent an outer surface of the object, (2) a rigging 204 (also referred to as a set of bones or a skeleton) that is used to animate (pose and keyframe) the skin 202, and (3) a connection or association of the skin to the rigging.

The skin 202 may be a sheet of polygons that is folded in three dimensions to represent a surface of an object or a person. For example, the skin 202 may be created and fitted over the bones 202 to create a representation 206, as illustrated in FIG. 2. The skin 202 may be composed of multiple polygons, such as triangles or other geometric shapes, with each polygon having a coloring, known as a texture. For illustration purposes, the skin 202 in FIG. 2 is shown as comprising multiple triangles with a transparent surface. However, when the skin 202 is rendered by the computing device 102 of FIG. 1, it should be understood that one or more of the multiple polygons of the skin 202 may have an opaque colored surface.

While the skinned rig model of FIG. 2 is illustrated with respect to creating a virtual representation of a human (e.g., a participant), the skinned rig model may be used to create and animate any type of object, including animate objects (e.g., humans, animals, etc.) as well as inanimate objects, such as a robot, a mechanical apparatus (e.g., reciprocating oil pump), an electronic device, an ack-ack type gun, or the like. For example, when using immersive teleconferencing, a representation of a salesperson may demonstrate representations of various products (e.g., “to load a disk into the gaming console, press the eject button and the tray will slide out”).

At least some of the bones in the rigging 204 may be connected to each other. In some cases, the bones in the rigging 204 may be organized hierarchically, with a parent bone (e.g., parent node) and one or more additional bones (e.g., child nodes). Each of the bones in the rigging 204 may have a three-dimensional transformation (which includes a position, a scale and an orientation), and, in some cases, a parent bone. The full transform of a child node may be a product of a parent transform and a transform of the child node, such that moving a thigh-bone may move a lower leg as well.

Each the bones in the rigging 204 in the skeleton may be associated with some portion of a participant's visual representation. For example, a process known as skinning may be used to associate at least some of the bones in the rigging 204 with one or more vertices of the skin 202. For example, in a representation of a human being, a bone (e.g., corresponding to a thigh bone) may be associated with one or more vertices associated with the polygons in the thigh of the representation 206. Portions of the skin 202 may be associated with multiple bones, with each bone having a weighting factor, known as a blend weight. The blend weights may enable the movement of the skin 202 near the joints of two or more bones to be influenced by the movement of the two or more bones. In some cases, the skinning process may be performed using a shader program of a graphics processing unit.

For a polygonal mesh of the skin 202, each vertex may have a weight for each bone. To calculate a final position of a vertex, each bone transformation may be applied to the vertex position, scaled by the corresponding weight of the bone. This algorithm may be referred to as matrix palette skinning, because the set of bone transformations (stored as transform matrices) form a palette for the skin vertex to choose from. For example, for a representation of a human, the skin 202 may include a mesh of approximately 10,000 or more points, with each point having a three (or more) dimensional vector identifying a location of the point in three dimensional space.

The rigging 204 may be fitted to the skin 202 in a pose known as a bind pose or a neutral pose. A current pose of the representation 206 may be expressed as a transformation relative to the bind pose. For example, the transformation may be applied to the bones of the bind pose to place the representation in the current pose. The bind pose (e.g., neutral pose) may be used as the starting pose, e.g., the pose of the representation 206 at time t(0). When the participant moves over time, the representation may be repositioned by determining coordinate transforms to apply to the bones.

The number of the bones in the rigging 204 may determine an accuracy of a movement of the representation 206. For example, the greater the number of the bones in the rigging 204, the more realistic the movement of the representation 206. Each vertex of the skin 202 may have an associated weight vector that includes weights of the bones that are attached to the vertex. For example, if there are n bones, a vertex i may have an associated weight vector w having n weights, e.g., w(i)=(w1, w2, . . . wn), where w1 is the weight associated with the first bone, w2 is the weight associated with the second bone, and wn is the weight associated with the nth bone. The weights of bones attached to the vertex i may have non-zero values while the remaining weights may be zero. When using fractional weights, the sum of the n weights w1 . . . wn may be 1.0. When one or more bones move, the corresponding vertices to which the bones are attached move proportionate to the weights of the bones for each of the vertices.

In FIG. 2, for illustration purposes, the rigging 204 includes 14 bones (e.g., numbered 1 through 14). It should be understood that in some implementations, a representation of an object may include more than 14 bones. One or more bones of the rigging 204 may be attached to some of the vertices of the skin 202 to create the representation 206. For example, a vertex 208 of a portion of the skin 202 that corresponds to an elbow may be attached to a third bone and a fourth bone. The vertex 208 may have an associated vector of 14 weights, e.g., w=(0, 0, 0.6, 0.4, 0, 0, 0, 0, 0, 0, 0, 0, 0, 0), where the third bone has a weight of 0.6, the fourth bone has a weight of 0.4, and the remaining twelve bones have a weight of zero. In this example, movement of the third bone is given greater weight (e.g., 0.6) than the movement of the fourth bone (e.g., 0.4). If the vertex 208 has an associated vector w=(0, 0, 0.5, 0.5, 0, 0, 0, 0, 0, 0, 0, 0, 0, 0), then the movement of the third bone and the fourth bone may equally weighted. The other vertices of the skin 202 that have bones from the rigging 204 attached to the vertices may similarly have an associated weight vector of 14 weights corresponding to the 14 bones of the rigging 204. Typically, up to four bones may be attached to a vertex. However, depending on the application and the desired accuracy of the representation, more than four bones or fewer than four bones may be attached to vertices of the skin 202.

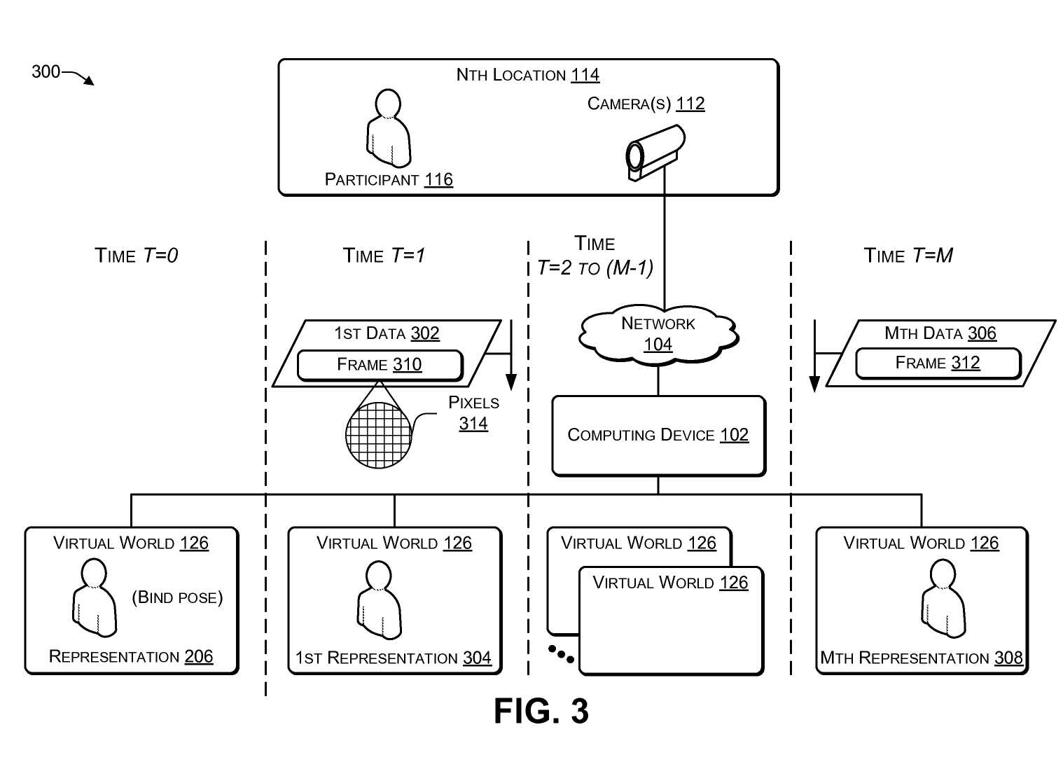

FIG. 3 is an illustrative architecture 300 that includes creating virtual representations based on camera data received over a period of time according to some implementations. FIG. 3 assumes that the one or more participants 116 includes a single participant. However, the same techniques may be extended to include multiple participants.

At a time t=0, the computing device 102 may create the representation 206. For example, the representation 206 may be in a bind pose.

At a time t=1, the computing device 102 may receive first data 302 from the one or more cameras 112 located at the Nth location 114 (where N>0). The computing device 102 may generate a first representation 304 corresponding to the participant 116 based on the first data 302. For example, the first representation 304 may be a skinned rig model representation, such as the representation 206 of FIG. 2.

Over a period of time, the computing device 102 may receive additional data from the one or more cameras 112 located at the Nth location 114. For example, the computing device 102 may receive the additional data at a particular frame rate (e.g., 15 fps, 30 fps, 60 fps, etc.) from the one or more cameras 112 located at the Nth location 114. The computing device 102 may generate (e.g., re-generate) one or more representations corresponding to the participant 116 based on the additional data. For example, the computing device 102 may generate the representations in response to receiving the additional data, in response to determining that the additional data includes information that was not included in the first data, at a predetermined interval, or any combination thereof. To illustrate, at a time t=M (where M>1), the computing device 102 may receive M^{th} data 302 from the one or more cameras 112 located at the N^{th} location 114. The computing device 102 may generate an M^{th} representation 308 corresponding to the participant 116 based on the M^{th} data 306.

Thus, a representation of the participant 116 may be updated from the first representation to the Mth representation 308 based on M data (e.g., starting with the first data 302 and up to and including the Mth data 306) received from the cameras 112. The first representation 304 may include skin, rigging, and texture that is generated based on a frame 310 included in the first data 302. In some cases, at least some of the first representation 304 may be extrapolated based on the first data 302. The number of parameters used to generate a representation corresponding to the participant 116 may be fixed, so the representation may be refined (e.g., improved accuracy) as more and more data is collected between time t and time t+m. The number of new animation parameters that may be estimated per frame may be relatively small as compared to an amount of data received in each frame provided by the cameras 112. The Mth representation 308 may include skin, rigging, and texture that is generated based on a frame 312 included in the Mth data 306. Thus, the computing device 102 may, in response to receiving frames (e.g., the frames 310, 312) from the cameras 112, estimate animation parameters and generate a representation, thereby generating m representations (e.g., from the first representation 304 to the Mth representation 308) corresponding to the participant 116. Each frame of data may include multiple pixels. For example, the frame 310 in the first data 302 may include the pixels 314.

At time t, the first representation 304 may be based on a set of (X, Y, Z, W)^{T} mesh points {xᵢ(0)} in homogeneous world coordinates, a corresponding set of (R, G, B)^{T} colors {cᵢ} (alternatively, pointers into a texture map may be used), a corresponding set of N-dimensional weight vectors {wᵢ}, and a set of N bones b=1, . . . , N. Each bone b in a local coordinate system may be defined by a coordinate transformation G_{b}(0) that maps the bone's local coordinates to real world coordinates. In some cases, the bones may be arranged into a hierarchy, where G_{b}(0) equals the composition G_{p(b)}(0)L_{b}(0) of a local coordinate transformation L_{b}(0) that maps the local coordinate system of bone b into the local coordinate system of a parent bone p(b) and the global coordinate transformation G_{p(b)}(0) of the parent bone p(b). The local coordinate transformation L_{b}(0) may be expressed as a rotation R(0) and a translation t(0), where t(0) is a constant (e.g., the length of the parent bone) and where R(0) may be constrained to rotate in one or two dimensions. The weight vector wᵢ=(wᵢ₁, . . . , w_{iN})^{T} may associate mesh point i with bone b according to weight w_{ib} such that the neutral model can be animated as follows:

xᵢ(t)=Σ_{b}w_{ib}G_{b}(t)G_{b}⁻¹(0)xᵢ(0) (1)

In equation (1), each point xᵢ(0) in the neutral mesh may be mapped by G_{b}⁻¹(0) to a fixed location in bone b's local coordinate system, and from there may be mapped by G_{b}(t) to a point in the world coordinate system at time t. The resulting points may be averaged using the weight vector wᵢ to determine the point xᵢ(t) at time t.

The textured mesh ({xᵢ(t)}, {cᵢ}) may be determined based on the first data 302 received from the one or more cameras 112 (e.g., cameras that provide both color and depth data). For example, for the jth pixel of the foreground object in camera k at time t, yⱼₖ(t) may be the homogeneous world coordinate of the pixel (e.g., provided by the one or more cameras 112), and yⱼₖ′(t) may be the corresponding color of the pixel by projecting ({xᵢ(t)}, {cᵢ}) onto each of the cameras 112. In other words, j(ikt) may be the index of the foreground pixel in the kth camera at time t “nearest” to the ith mesh point. In this example:

yⱼ₍ᵢₖₜ₎ₖ(t)=xᵢ(t)+nⱼ₍ᵢₖₜ₎ₖ(t) (2)

yⱼ₍ᵢₖₜ₎ₖ′(t)=cᵢ+nⱼ₍ᵢₖₜ₎ₖ′(t) (3)

where nⱼₖ(t) and nⱼₖ′(t) may represent sensor noise. A more accurate color model may modulate cᵢ by a function of the light direction and the vector normal to xᵢ (t). Equations (2) and (3) represent an observation model.

An alternative observation model may include swapping a direction of the projection, where i(jkt) may be the index of the mesh point “nearest” to the jth foreground pixel in the kth camera at time t. The alternate observation model may be expressed mathematically as:

yⱼₖ(t)=xᵢ₍ⱼₖₜ₎(t)+nⱼₖ(t) (4)

yⱼₖ′(t)=cᵢ₍ⱼₖₜ₎+nⱼₖ′(t) (5)

While in some embodiments the above two observation models may be combined, the alternate observation model expressed in equations (4) and (5) is used below for ease of understanding.

Frames of data may be received at times t=1, 2, . . . M. After every frame t, the computing device 102 may determine {xᵢ(0)}, {cᵢ}, {wᵢ}, and {G_{b}(0)} using data from the preceding frames (e.g., frames 1, . . . , t). In addition, the computing device 102 may determine a current pose {G_{b}(t)}. The computing device 102 may minimize a Mahalanobis norm (or equivalently maximize the likelihood) of the observation noise over all frames received from the cameras 112. For ease of understanding, the following equation assumes a single camera and ignores the colors. However, it should be understood that the following equation may be easily modified to include color information from multiple cameras. Thus, the computing device 102 may minimize:

E({xᵢ(0)},{wᵢ},{G_{b}(t)})=ΣₜΣⱼ∥nⱼ(t)∥_{Σ}_{ⱼ}₍ₜ₎² (6)

where

nⱼ(t)=yⱼ(t)−Σ_{b}w_{i(jt)b}G_{b}(t)G_{b}⁻¹(0)xᵢ₍ⱼₜ₎(0) (7)

represents sensor noise, where a corresponding covariance is expressed as:

Σⱼ(t)=E[nⱼ(t)nⱼ^{T}(t)] (8)

a corresponding square norm is expressed as:

∥nⱼ(t)∥_{Σ}_{ⱼ}₍ₜ₎²=nⱼ(t)Σⱼ⁻¹(t)nⱼ^{T}(t) (9)

In equation (6), E describes an amount of error between data provided by a camera and a representation that is generated based on the data, xᵢ(0) represents the mesh points of the skin 202 in the bind pose, wᵢ represents the weight vector associated with each vertex of the skin 202 to which one or more bones of the rigging 204 are attached, and G_{b}(t) represents a coordinate transformation of each bone b at time t, specifically including the coordinate transformation G_{b}(0) of bone b in the bind pose.

Equation (7) describes nⱼ(t), which is an amount of noise between the data yⱼ(t) provided by the camera at time t and the representation that is generated based on the data. Equation (7) may be used to minimize the amount of noise, e.g., minimize a difference between what the camera observes and the representation.

In some cases, minimizing equation (6) may be computationally intensive as equation (6) is non-linear in its parameters and may involve over 100,000 parameters. An alternate method is to minimize E({xᵢ(0)}, {wᵢ}, {G_{b}(t)}) by an alternating minimization over its different sets of parameters, as described below in equations (10), (11), (12), (13), and (14), using least squares techniques. The alternate methods described in equations (10)-(14) may be less computationally intensive to solve as compared to minimizing equation (6) directly because equation (6) is linear in each set of parameters, and hence simple least squares techniques can be used to minimize equation (6) for each set of parameters. Moreover, each of the equations (10)-(14) may involve at most 3,000 dimensions, reducing the computational requirements by several orders of magnitude. Initially, {xᵢ(0)}, {wᵢ}, and {G_{b} (0)} may be estimated based on a model of a generic human. At a subsequent time t, these parameters as well as the current pose {G_{b}(t)} may be determined based on iterating through the following five steps:

Finding i(jt) given {xᵢ(0)},{wᵢ},{G_{b}(0)},{G_{b}(t)} (10)

Finding {G_{b}(t)} given {xᵢ(0)},{wᵢ},{G_{b}(0)},i(jt)} (11)

Finding {xᵢ(0)} given {wᵢ},{G_{b}(0)},{G_{b}(t)},i(jt)} (12)

Finding {wᵢ} given {xᵢ(0)},{G_{b}(0)},{G_{b}(t)},i(jt)} (13)

Finding {G_{b}(0)} given {xᵢ(0)},{wᵢ},{G_{b}(t)},i(jt)} (14)

In step (10), the computing device 102 may identify (e.g., determine) vertices in the rigging 204 of FIG. 2 corresponding to pixels in the data (e.g., one of the data 302 to 306). For example, the computing device 102 may identify an i^{th} vertex (e.g., index) of the skin 202 that corresponds to a j^{th} pixel in a frame t (e.g., data provided by a camera). The correspondences i(jt) for all pixels j at time t may be determined by finding the correspondences i(jt) that make the synthesized vertex position xᵢ₍ⱼₜ₎(t)=Σ_{b}w_{i(jt)b}G_{b}(t)G_{b}⁻¹(0)xᵢ₍ⱼₜ₎(0) as close as possible to the observed pixel data yⱼ for all pixels j at time t. In this step, the vertex positions xᵢ(0) in the bind pose, the bind pose transformations G_{b}(0), the current pose transformations G_{b}(t), and the weights w_{ib} are all assumed to be known.

In step (11), the computing device 102 may determine the current pose transformation G_{b}(t) (e.g., a 4×4 matrix representing a coordinate transformation) for each bone b at time t. For example, the current pose transformations G_{b}(t) for all bones b at time t may be determined by finding the transformations G_{b}(t) that make the synthesized vertex position xᵢ₍ⱼₜ₎(t)=Σ_{b}w_{i(jt)b}G_{b}(t)G_{b}⁻¹(0)xᵢ₍ⱼₜ₎(0) as close as possible to the observed pixel data yⱼ for all pixels j at time t. In this step, the correspondences i(jt), the vertex positions xᵢ(0) in the bind pose, the bind pose transformations G_{b}(0), and the weights w_{ib} are all assumed to be known.

In step (12), the computing device 102 may determine xᵢ(0), e.g., determine 3D (e.g., x, y, and z) coordinates for each vertex i of the skin 202 in the bind pose. For example, the vertex positions xᵢ(0) may be determined by finding the positions xᵢ(0) that make the synthesized vertex position xᵢ₍ⱼₜ₎(t)=Σ_{b}w_{i(jt)b}G_{b}(t)G_{b}⁻¹(0)xᵢ₍ⱼₜ₎(0) as close as possible to the observed pixel data yⱼ for all pixels j and all times t up to the present time. In this step, the correspondences i(jt), the bind pose transformations G_{b}(0), the current pose transformations G_{b}(t), and the weights w_{ib} are all assumed to be known.

In step (13), the computing device 102 may determine wⱼ, e.g., a vector w of weights for each vertex i of the skin 202. For example, the weights wᵢ may be determined by finding the weights wᵢ that make the synthesized vertex position xᵢ₍ⱼₜ₎(t)=Σ_{b}w_{i(jt)b}G_{b}(t)G_{b}⁻¹(0)xᵢ₍ⱼₜ₎(0) as close as possible to the observed pixel data yⱼ for all pixels j and all times t up to the present time. In this step, the correspondences i(jt), the vertex positions xᵢ(0) in the bind pose, the bind pose transformations G_{b}(0), and the current pose transformations G_{b}(t) are all assumed to be known.

In step (14), the computing device 102 may determine G_{b}(0), e.g., the position of the bones in rigging 204 in the bind pose (e.g., at time 0). For example, bind pose transformations G_{b}(0) may be determined by finding the transformations G_{b}(0) that make the synthesized vertex position xᵢ₍ⱼₜ₎(t)=Σ_{b}w_{i(jt)b}G_{b}(t)G_{b}⁻¹(0)xᵢ₍ⱼₜ₎(0) as close as possible to the observed pixel data yⱼ for all pixels j and all times t up to the present time. In this step, the correspondences i(jt), the vertex positions xᵢ(0) in the bind pose, the current pose transformations G_{b}(t), and the weights w_{ib} are all assumed to be known.

In steps (12), (13), and (14), at each time t, the computing device 102 may refine (e.g., re-determine) parameters xᵢ(0), G_{b}(0), and w_{ib} related to the original the bind pose. Thus, the computing device 102 may re-compute the bind pose based on the additional data received from the cameras 116 during the time period between time t=0 and time t=M. The recomputed bind pose at time t=M may be a more accurate representation of the characteristics of the corresponding participant 116.

The equations (10)-(14) may be repeatedly solved for each subsequent time t (e.g., for each frame received from the cameras 112) until convergence. The norm of the noise nⱼ(t) for all t and j may be non-increasing at each step and may be bounded below by zero, and therefore each of the equations may converge. The equations (10)-(14) may be solved in any order. For example, in some implementations, at least some of the equations (10)-(14) may be determined (e.g., solved) substantially contemporaneously (e.g., in parallel). To illustrate, using multiple processors or a multiple core processor, at least two or more of the equations (10)-(14) may be solved substantially at the same time (e.g., in parallel).

In general the minimizations are constrained. In particular, the fourth component of xᵢ must equal 1, the weights wᵢ₁, . . . , w_{iN} must sum to 1, and the transformations G_{b}(t) must be rigid with specified limits on their rotational freedom. However, for simplicity in the following we will ignore these constraints.

Equations (10) and (11) may be considered a generalization of iterative closest point (e.g., from one to multiple bones). Equations (11), (12), (13), or (14) may be solved using linear methods, such as least squares techniques, as described herein.

For example, for equation (10), if yⱼ(t) is a world coordinate of a jth foreground pixel in a tth frame, then for each j and t the computing device 102 may select i(jt) to minimize the norm of nⱼ(t) in:

yⱼ(t)=Σ_{b}w_{i(jt)b}G_{b}(t)G_{b}⁻¹(0)xᵢ₍ⱼₜ₎(0)nⱼ(t) (15)

A linear method for equation (11) may be expressed as:

aᵢ^{T}=[w_{ib}_{₁}xᵢ^{T}(0)G_{b}_{₁}^{-T}(0) . . . w_{ib}_{_{N}}xᵢ^{T}(0)G_{b}_{_{N}}^{-T}(0)] (16)

where, for each t, the computing device 102 may select {G_{b}(t)} using least squares to minimize the norm of the noise in

$${y}_{j}^{T} ( t ) = {a}_{i ( jt )}^{T} [ \begin{matrix}{G}_{{b}_{1}}^{T} ( t ) \\ ⋮ \\ {G}_{{b}_{N}}^{T} ( t )\end{matrix} ] + {n}_{j}^{T} ( t ) ,$$

stacking the equations for all j.

A linear method for equation (12) may be expressed as:

Bᵢ(t)=Σ_{b}w_{ib}G_{b}(t)G_{b}⁻¹(0) (17)

where the computing device 102 may select {xᵢ(0)} using least squares to minimize the norm of the noise in yⱼ(t)=Bᵢ₍ⱼₜ₎(t)xᵢ₍ⱼₜ₎(0)+nⱼ(t), stacking the equations for all t and j.

A linear method for equation (13) may be expressed as:

Cᵢ(t)=[G_{b}_{₁}(t)G_{b}_{₁}⁻¹(0)xᵢ(0) . . . G_{b}_{_{N}}(t)G_{b}_{_{N}}⁻¹(0)xᵢ(0)] (18)

where the computing device 102 may select {wᵢ} using least squares to minimize the norm of the noise in yⱼ(t)=Cᵢ₍ⱼₜ₎(t)wᵢ₍ⱼₜ₎+nⱼ(t), stacking the equations for all t and j. In some cases, the computing device 102 may also regularize with ∥wᵢ∥₁ to promote sparsity.

A linear method for equation (14) may be expressed as:

Gᵢ(t)=[w_{ib}_{₁}G_{b}_{₁}(t) . . . w_{ib}_{_{N}}G_{b}_{_{N}}(t)] (19)

and

Dᵢ(t)=[x_{iX}(0)Gᵢ(t),x_{iY}(0)Gᵢ(t),x_{iZ}(0)Gᵢ(t),x_{iW}(0)Gᵢ(t)] (20)

then the computing device 102 may select {G_{b}(0)} using least squares to minimize the norm of the noise in:

$${y}_{j} ( t ) = {D}_{i ( jt )} ( t ) pile - ( \begin{matrix}{G}_{{b}_{1}}^{- 1} ( 0 ) \\ ⋮ \\ {G}_{{b}_{N}}^{- 1} ( 0 )\end{matrix} ) + {n}_{j} ( t ) \qquad ( 21 )$$

where pile[x, y, z, w]=[x^{T}, y^{T}, z^{T}, w^{T}]^{T} stacking the equations for all t and j.

To minimize the norm of the noise instead of the squared error, the computing device 102 may first multiply one or more of the equations (15)-(21) by Σⱼ^{-1/2}(t) to normalize the noise.

One or more of the equations (13), (14), and (15) may be implemented recursively. A recursive implementation may reduce an amount of computation to be performed because a result from a previous computation may be used in a subsequent computation. For example, using a recursive algorithm, at time t, a first result may be determined based on first data received from a camera. At time t+1, based on second data received from the camera, a second result may be recursively determined using the first result. At time t+2, based on third data received from the camera, a third result may be recursively determined using the first result and the second result, and so on. If p(τ)=M(τ)q+r(τ) is a vector equation for each τ=1, . . . , t, then stacking these equations results in the following vector equation:

p(1:t)=M(1:t)q+r(1:t) (22)

where

p(1:t)=[p^{T}(1), . . . , p^{T}(t)]^{T}, (23)

M(1:t)=[M^{T}(1), . . . , M^{T}(t)]^{T}, and (24)

r(1:t)=[r^{T}(1), . . . , r^{T}(t)]^{T}. (25)

Then, the vector q*(t) that minimizes the norm of r(1:t) may be computed as:

q*(t)=[M^{T}(1:t)M(1:t)]⁻¹M^{T}(1:t)p(1:t) (26)

which is equivalent to:

$${[ {\sum }_{τ = 1}^{t - 1} {M}^{T} ( τ ) M ( τ ) + {M}^{T} ( t ) M ( t ) ]}^{- 1} [ {\sum }_{τ = 1}^{t - 1} {M}^{T} ( τ ) p ( τ ) + {M}^{T} ( t ) p ( t ) ] \qquad ( 27 )$$

Thus, to compute q*(t) at each time t the computing device 102 may update the square matrix

$${M}^{T} M ( t - 1 ) {=}^{def} {\sum }_{τ = 1}^{t - 1} {M}^{T} ( τ ) M ( τ )$$

by adding M^{T}(t)M(t), and update the vector

$${M}^{T} p ( t - 1 ) {=}^{def} {\sum }_{τ = 1}^{t - 1} {M}^{T} ( τ ) p ( τ )$$

by adding M^{T}(t)p(t), before taking the inverse of the former and multiplying by the latter. The updates may also be performed with a forgetting factor μ, e.g., M^{T}M(t)=(1−μ)M^{T}M(t−1)+μM^{T}(t)M(t) and M^{T}p(t)=(1−μ)M^{T}p(t−1)+μM^{T}(t)p(t). Thus, the computing device 102 may determine the representations 304, 308 using a recursive least squares version of the algorithm described in equations (10)-(14). Moreover, the recursive implementation may include a Kalman filter interpretation, such that the forgetting factor μ may be interpreted as the covariance of the observation vector relative to the covariance of the state vector in a Kalman filter.

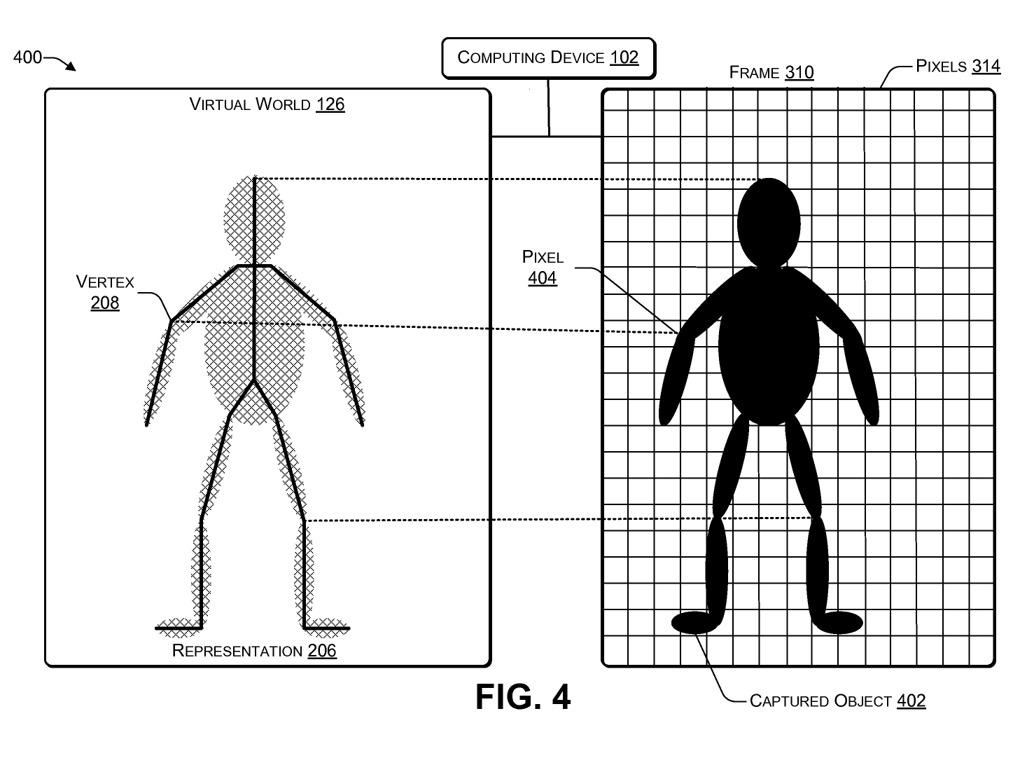

FIG. 4 is an illustrative architecture 400 that includes identifying vertices of a representation that correspond to pixels of an object captured in a frame according to some implementations. The data received from one or more cameras may include one or more frames, such as the frame 310. Each frame may include multiple pixels. For example, the frame 310 may include the pixels 314. Each frame may include at least a portion of a captured object 402. For example, the captured object 402 may include a capture of a participant (e.g., one of the participants 110, 116 of FIG. 1). The computing device 102 may identify (e.g., determine) each vertex in the rigging of the representation 206 that has a corresponding pixel in the captured object 402, as discussed above with respect to equation (10). As illustrated in FIG. 4, the vertex 208 may be determined as corresponding to a pixel 404 of the pixels 314.

### Example Processes

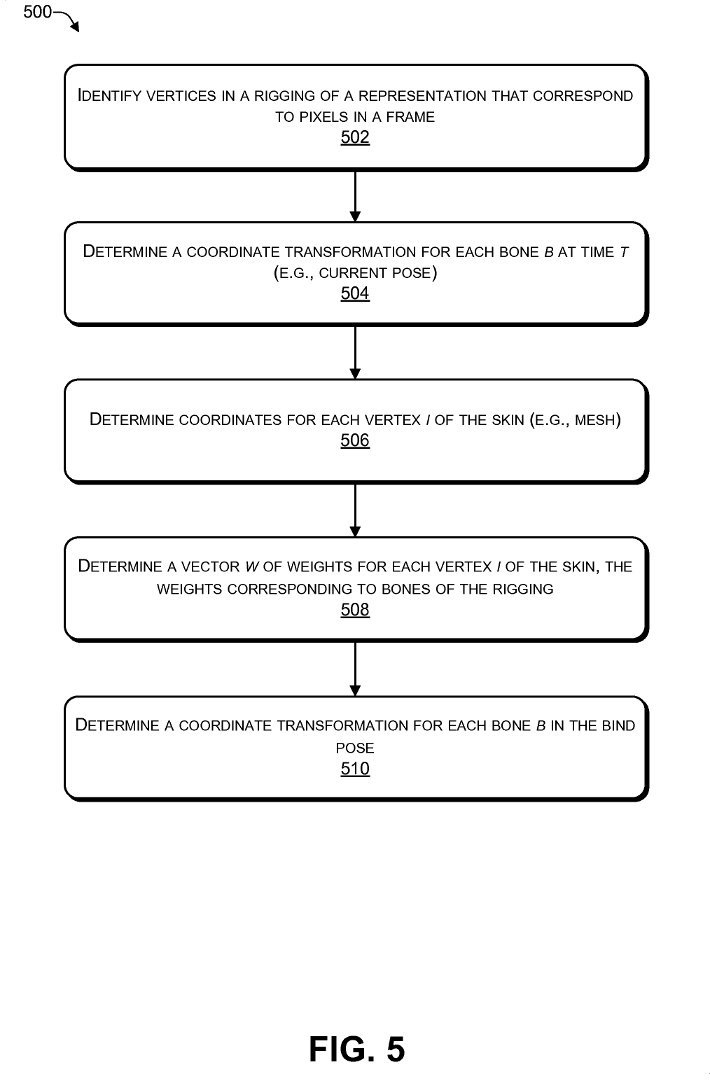

In the flow diagrams of FIGS. 5-8, each block represents one or more operations that can be implemented in hardware, software, or a combination thereof. In the context of software, the blocks represent computer-executable instructions that, when executed by one or more processors, cause the processors to perform the recited operations. Generally, computer-executable instructions include routines, programs, objects, modules, components, data structures, and the like that perform particular functions or implement particular abstract data types. The order in which the blocks are described is not intended to be construed as a limitation, and any number of the described operations can be combined in any order and/or in parallel to implement the processes. For discussion purposes, the processes 500, 600, 700, and 800 are described with reference to the architectures 100, 200, 300, and 400 as described above, although other models, frameworks, systems and environments may implement these processes.

FIG. 5 is a flow diagram of an example process 500 that includes identifying vertices in a rigging that correspond to pixels in a frame according to some implementations. The process 500 may be performed by the computing device 102 of FIGS. 1, 3, and 4.

At 502, vertices in a rigging of a representation that correspond to pixels in a frame may be identified. For example, in FIG. 4, the computing device 102 may identify vertices of the representation 206 that correspond to the pixels 314, e.g., as described in more detail above in the discussion of equation (10). To illustrate, the computing device 102 may determine that the vertex 208 corresponds to the pixel 404.

At 504, a coordinate transformation for each bone b at time t may be determined. The coordinate transformation may be used to place bone b in a current pose (e.g., in the virtual world), e.g., as described in more detail above in the discussion of equation (11).

At 506, coordinates (e.g., three dimensional coordinates) may be determined for each vertex i of the skin, e.g., as described in more detail above in the discussion of equation (12).

At 508, a vector w of weights for each vertex i of the skin. The weights may correspond to bones of the rigging. For example, in FIG. 2, the computing device 102 may determine a vector of weights for each vertex of the skin 202 to which one or more bones of the rigging 204 are attached, as described in more detail above in the discussion of equation (13).

At 510, a coordinate transformation for each bone b in the bind pose is determined. For example, in FIG. 3, the computing device 102 may generate (e.g., re-generate) the representation 206 (e.g., the bind pose) based on the Mth data 306. After movements of the participant 116 are captured by the cameras 112 and sent to the computing device 102 as new data (e.g., the Mth data 306), the computing device may re-generate the representation 206 (e.g., the bind pose) to include the new data. For example, the new data may include information on portions of the participant 116 that were previously unavailable (e.g., occluded from view) to the cameras 112. Generating the representation 206 is described above in more detail in the discussion of equation (14).

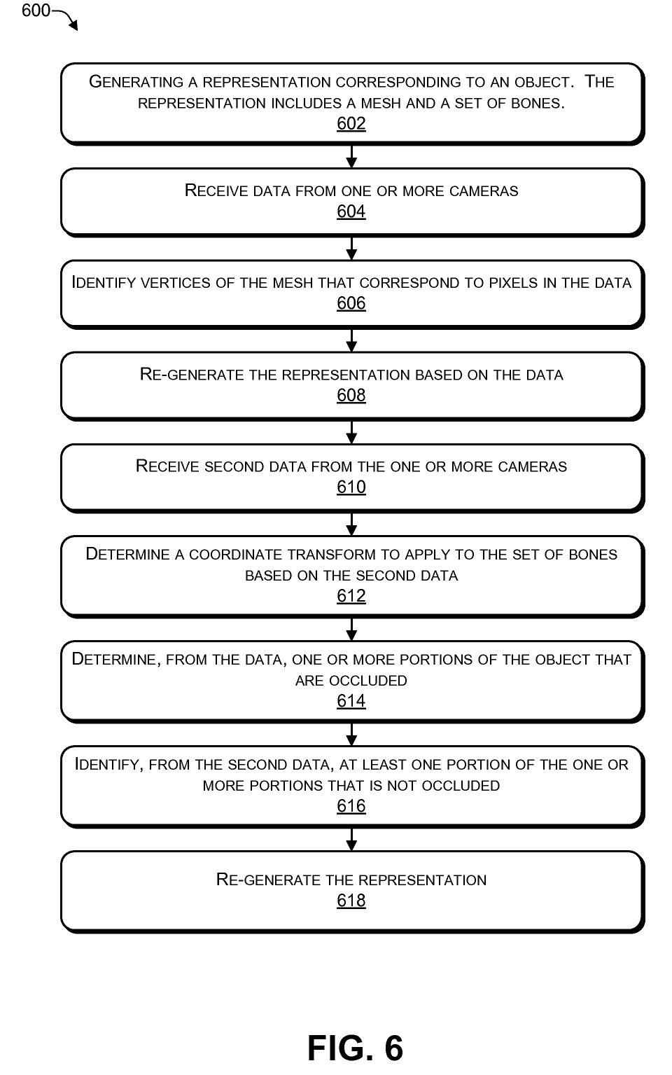

FIG. 6 is a flow diagram of an example process 600 that includes generating a representation corresponding to an object according to some implementations. The process 600 may be performed by the computing device 102 of FIGS. 1, 3, and 4.

AT 602, a representation corresponding to an object may generated. The representation may include a mesh and a set of bones. For example, in FIG. 1, the computing device may generate the representations 128 corresponding to the participants 110, 116. To illustrate, the representation 206 (e.g., one of the representations 128) of FIG. 2 may include a mesh (e.g., the skin 202) and a set of bones (e.g., the rigging 204).

At 604, data may be received from one or more cameras. For example, the computing device 102 may receive the data 118 from the one or more cameras 106, 112.

At 608, the representation may be re-generated based on the data. For example, initially a representation of the representations 128 may be based on a predetermined model of a human being. After receiving the data 118, the computing device 102 may re-generate the representation based on the data 118.

At 610, second data may be received from the one or more cameras. For example, in FIG. 1, the computing device 102 may receive the additional data 136 from the cameras 106, 112.

At 612, a coordinate transform to apply to the set of bones may be determined based on the second data. For example, the computing device 102 may determine a coordinate transform to apply to the set of bones of the representation in the bind pose to reposition the representation to a position that corresponds to the participant's current position.

At 614, one or more portions of the object that are occluded may be determined from the data. For example, in FIG. 1, the computing device 102 may identify portions of the participants 110, 116 that are occluded from the cameras 106, 112 based on the data 118.

At 616, identify at least one portion of the one or more portions that is not occluded from the second data. For example, one of the participants 110, 116 may move enabling the cameras 106, 112 to capture the additional data 136 that includes at least one portion of the one or more previously occluded portions.

At 618, the representation may be re-generated. For example, after receiving the additional data 136 that includes information on previously occluded portions of one of the participants 110, 116, the computing device 102 may re-generate (e.g., generate) a corresponding one of the representations 128 based on the additional data 136. For example, the computing device 102 may apply the coordinate transform determined in 612 to the representation in the bind pose to position the representation to correspond to a pose of the corresponding participant.

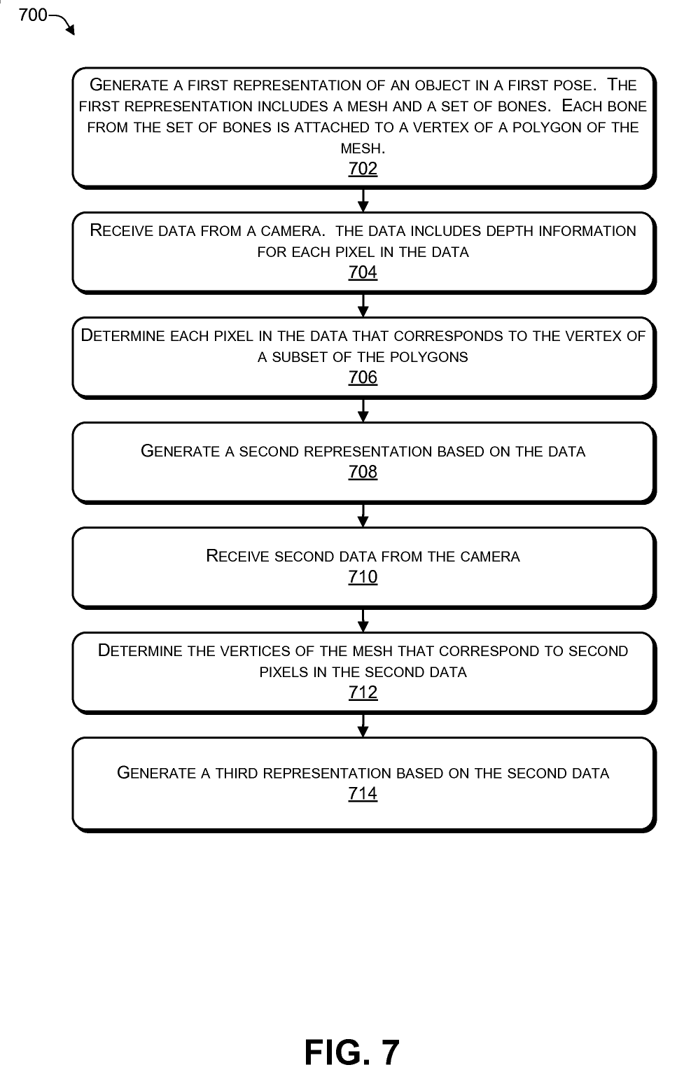

FIG. 7 is a flow diagram of an example process 700 that includes generating a first representation of an object in a first pose according to some implementations. The process 700 may be performed by the computing device 102 of FIGS. 1, 3, and 4.

At 702, a first representation corresponding to an object in a first pose may be generated. The first representation may include a mesh and a set of bones. Each bone from the set of bones may be attached to a vertex of a polygon of the mesh. For example, in FIG. 3, the computing device 102 may generate the representation 206. The representation 206 may include a mesh (e.g., the skin 202) and a set of bones (e.g., the rigging 204). Each bone of the rigging 204 may be attached to a vertex (e.g., such as the vertex 208) of a polygon of the skin 202.

At 704, data may be received from a camera. The data may include depth information for each pixel in the data. For example, in FIG. 3, the first data 302 that is received from the cameras 112 may include color (e.g., RGB) data and depth data. The depth data may identify a distance of the pixel from the camera.

At 706, determine each pixel in the data that corresponds to the vertex of a subset of the polygons. For example, in FIG. 4, the computing device 102 may identify the vertices of the representation 206 that correspond to the pixels 314.

At 708, a second representation may be generated based on the data. For example, in FIG. 3, the computing device 102 may generate the first representation 304 based on the first data 302.

At 710, second data may be received from the camera. For example, in FIG. 3, the computing device 102 may receive the Mth data 306 from the cameras 112.

At 712, vertices of the mesh that correspond to second pixels in the second data may be determined. For example, in FIG. 3, the computing device 102 may determine which vertices of the mesh of the Mth representation 308 correspond to pixels in the Mth data 306.

At 714, a third representation may be generated based on the second data. For example, after receiving the Mth data 306, the computing device 102 may generate the Mth representation 308. A difference between the Mth representation 308 and the participant 116 may be less than a difference between the first representation 304 and the participant 116.

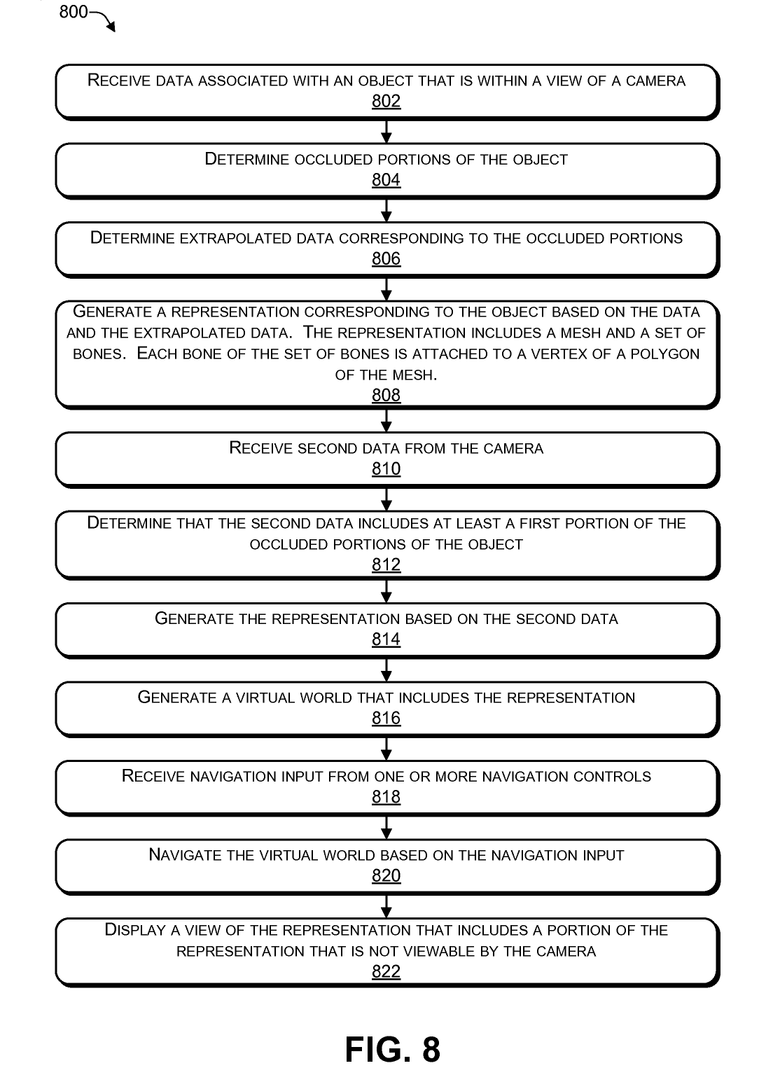

FIG. 8 is a flow diagram of an example process 800 that includes receiving data associated with an object that is within a view of a camera according to some implementations. The process 800 may be performed by the computing device 102 of FIGS. 1, 3, and 4.

At 802, data associated with an object that is within a view of a camera is received. For example, in FIG. 3, the computing device 102 may receive the first data 302. The first data 302 may include the participant 116 who is within a view of the one or more cameras 112.

At 804, occluded portions of the object are determined. For example, in FIG. 3, the computing device 102 may identify portions of the participant 116 that are occluded from a view of the one or more cameras 112.

At 806, extrapolated data corresponding to the occluded portions may be determined. For example, in FIG. 3, the computing device 102 may extrapolate data corresponding to the occluded portions of the participant 116. The extrapolated data may be determined based on a predetermined representation and the first data 302.

At 808, a representation corresponding to the object may be generated based on the data and the extrapolated data. The representation may include a mesh and a set of bones. Each bone of the set of bones may be attached to a vertex of a polygon of the mesh. For example, in FIG. 3, the computing device 102 may generate the first representation 304 based on the first data 302 and the predetermined representation 206. The first representation 304 may include a mesh (e.g., the skin 202) and a set of bones (e.g., the rigging 204).

At 810, second data may be received from the camera. For example, in FIG. 3, the computing device 102 may receive the Mth data 306 from the one or more cameras 112.

At 812, a determination may be made that the second data includes at least a first portion of the occluded portions of the object. For example, in FIG. 3, the computing device 102 may determine that the Mth data 306 includes information associated with previously occluded portions of the participant 116.

At 814, a representation may be generated based on the second data. For example, in FIG. 3, the computing device 102 may generate the Mth representation 308 based on the Mth data 306. When the Mth data 306 includes information associated with previously occluded portions of the participant 116, the Mth representation 308 may more accurately correspond to the participant 116 as compared to previously generated representations, such as the first representation 304.

At 816, a virtual world that includes the representation may be generated. For example, in FIG. 1, the computing device 102 may generate the virtual world 126 that includes the representations 128.

At 818 navigation input may be received from one or more navigation controls. For example, in FIG. 1, the computing device 102 may receive navigation input from the one or more navigation controls 134.

At 820, the virtual world may be navigated based on the navigation input. For example, in FIG. 1, the navigational controls 134 of the viewing device 132 may enable the viewers 130 to navigate the virtual world 126. The computing device 102 may display different views of the virtual world 126 based on the navigation input. For example, navigation input to move in a particular direction a particular amount may cause the computing device 102 to display a view of the virtual world 126 that corresponds to moving in the particular direction the particular amount. In this way, the viewers 130 may view portions of the representations 128 that may be occluded from the view of the cameras 106, 112.

At 822, a view of the representation that includes a portion of the representation that is not viewable by the camera may be displayed. For example, in response to navigation input from the navigation controls 134, the computing device 102 may display a view of one or more of the representations 128 (e.g., a back view or a side view of a representation) that may not be viewable by the cameras 106, 112. To illustrate, a particular camera of the cameras 106, 112 may be stationary (e.g., fixed in a particular position). A particular participant of the participants 110, 116 may face the camera such that the sides and the back of the particular participant are occluded (e.g., not visible) to the particular camera. However, the navigational controls 134 may enable the viewers 130 to view the sides and the back of a particular representation of the representations 128 that corresponds to the particular participant. Thus, the virtual world 126 may enable the viewers 130 to view portions of the representations 128 that are not viewable using the cameras 106, 112. This may enable the participants 110, 116 and the viewers 130 to engage in immersive teleconferencing despite the inability of the cameras 106, 112 to provide views of all portions of the participants 110, 116.

### Example Computing Device and Environment

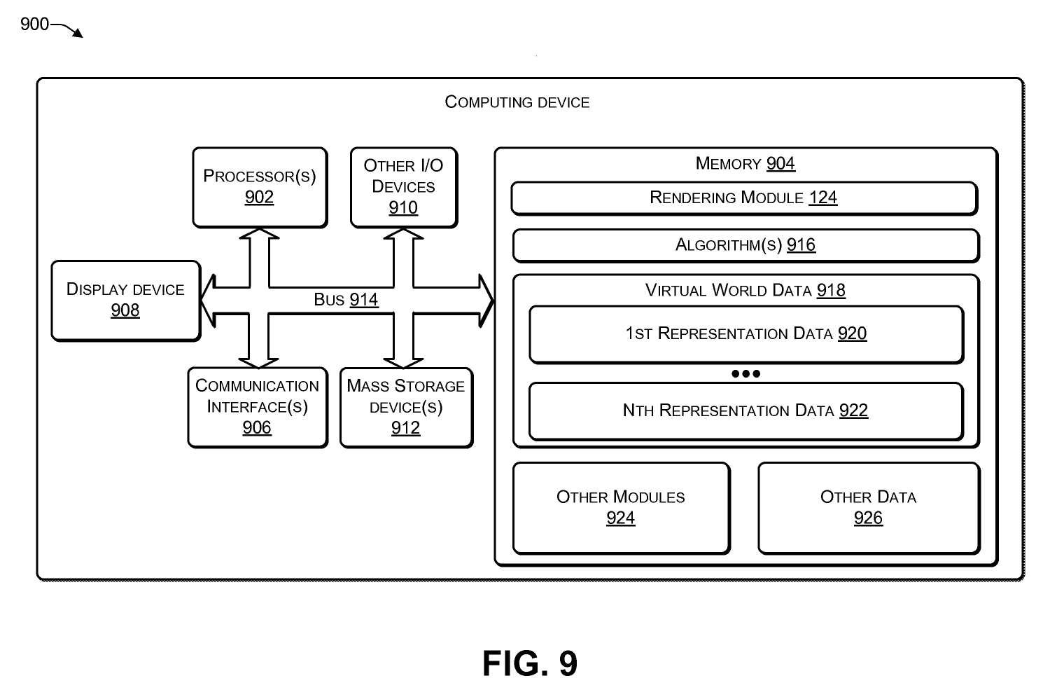

FIG. 9 illustrates an example configuration of a computing device 800 and environment that can be used to implement the modules and functions described herein. For example, the computing device 102 or the viewing device 132 may include an architecture that is similar to or based on the computing device 900.

The computing device 900 may include one or more processors 902, a memory 904, communication interfaces 906, a display device 908, other input/output (I/O) devices 910, and one or more mass storage devices 912, able to communicate with each other, such as via a system bus 914 or other suitable connection.

The processor 902 may be a single processing unit or a number of processing units, all of which may include single or multiple computing units or multiple cores. The processor 902 may be implemented as one or more microprocessors, microcomputers, microcontrollers, digital signal processors, central processing units, state machines, logic circuitries, and/or any devices that manipulate signals based on operational instructions. Among other capabilities, the processor 902 may be configured to fetch and execute computer-readable instructions stored in the memory 904, mass storage devices 912, or other computer-readable media.

Memory 904 and mass storage devices 912 are examples of computer storage media for storing instructions which are executed by the processor 902 to perform the various functions described above. For example, memory 904 may generally include both volatile memory and non-volatile memory (e.g., RAM, ROM, or the like). Further, mass storage devices 912 may generally include hard disk drives, solid-state drives, removable media, including external and removable drives, memory cards, flash memory, floppy disks, optical disks (e.g., CD, DVD), a storage array, a network attached storage, a storage area network, or the like. Both memory 904 and mass storage devices 912 may be collectively referred to as memory or computer storage media herein, and may be a non-transitory media capable of storing computer-readable, processor-executable program instructions as computer program code that can be executed by the processor 902 as a particular machine configured for carrying out the operations and functions described in the implementations herein.

Although illustrated in FIG. 9 as being stored in memory 904 of computing device 900, the rendering module 124, algorithms 916, virtual world data 918, other modules 924 other data 926, or portions thereof, may be implemented using any form of computer-readable media that is accessible by the computing device 900. As used herein, “computer-readable media” includes computer storage media.

Computer storage media includes volatile and non-volatile, removable and non-removable media implemented in any method or technology for storage of information, such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device.

The computing device 900 may also include one or more communication interfaces 906 for exchanging data with other devices, such as via a network, direct connection, or the like, as discussed above. The communication interfaces 806 can facilitate communications within a wide variety of networks and protocol types, including wired networks (e.g., LAN, cable, etc.) and wireless networks (e.g., WLAN, cellular, satellite, etc.), the Internet and the like. Communication interfaces 806 can also provide communication with external storage (not shown), such as in a storage array, network attached storage, storage area network, or the like.

A display device 908, such as a monitor may be included in some implementations for displaying information and images to users. Other I/O devices 810 may be devices that receive various inputs from a user and provide various outputs to the user, and may include a keyboard, a remote controller, a mouse, a printer, audio input/output devices, and so forth.

Memory 904 may include modules and components for training machine learning algorithms (e.g., PRFs) or for using trained machine learning algorithms according to the implementations described herein. The memory 904 may include multiple modules to perform various functions, such as one or more rendering module 124 and one or more modules implementing various algorithm(s) 916. The algorithms 916 may include software modules that implement various algorithms to implement the various equations and techniques described herein. The memory 904 may include virtual world data 918 that is used to generate the virtual world 126 of FIG. 1. The virtual world 918 may include data associated with different objects that are displayed in the virtual world, such as first representation data 920 up to and including Nth representation data 922 corresponding to N of the representations 128 of FIG. 1. The memory 904 may also include other modules 924 that implement other features and other data 926 that includes intermediate calculations and the like. The other modules 820 may include various software, such as an operating system, drivers, communication software, or the like.

The example systems and computing devices described herein are merely examples suitable for some implementations and are not intended to suggest any limitation as to the scope of use or functionality of the environments, architectures and frameworks that can implement the processes, components and features described herein. Thus, implementations herein are operational with numerous environments or architectures, and may be implemented in general purpose and special-purpose computing systems, or other devices having processing capability. Generally, any of the functions described with reference to the figures can be implemented using software, hardware (e.g., fixed logic circuitry) or a combination of these implementations. The term “module,” “mechanism” or “component” as used herein generally represents software, hardware, or a combination of software and hardware that can be configured to implement prescribed functions. For instance, in the case of a software implementation, the term “module,” “mechanism” or “component” can represent program code (and/or declarative-type instructions) that performs specified tasks or operations when executed on a processing device or devices (e.g., CPUs or processors). The program code can be stored in one or more computer-readable memory devices or other computer storage devices. Thus, the processes, components and modules described herein may be implemented by a computer program product.

Furthermore, this disclosure provides various example implementations, as described and as illustrated in the drawings. However, this disclosure is not limited to the implementations described and illustrated herein, but can extend to other implementations, as would be known or as would become known to those skilled in the art. Reference in the specification to “one implementation,” “this implementation,” “these implementations” or “some implementations” means that a particular feature, structure, or characteristic described is included in at least one implementation, and the appearances of these phrases in various places in the specification are not necessarily all referring to the same implementation.

### CONCLUSION

Although the subject matter has been described in language specific to structural features and/or methodological acts, the subject matter defined in the appended claims is not limited to the specific features or acts described above. Rather, the specific features and acts described above are disclosed as example forms of implementing the claims. This disclosure is intended to cover any and all adaptations or variations of the disclosed implementations, and the following claims should not be construed to be limited to the specific implementations disclosed in the specification. Instead, the scope of this document is to be determined entirely by the following claims, along with the full range of equivalents to which such claims are entitled.

What is claimed is:

1. A computing device comprising:
one or more processors;
one or more computer-readable storage media storing instructions executable by the one or more processors to perform acts comprising:
generating a representation corresponding to an object, the first representation comprising a mesh and a set of bones;
receiving data from one or more cameras, the data comprising color data and depth data;
identifying vertices of the mesh that correspond to pixels in the data; and
re-generating the representation based on the data.

2. The computing device of claim 1, the acts further comprising:
recursively re-generating the representation in response to receiving additional data from the one or more cameras.

3. The computing device of claim 1, wherein re-generating the representation based on the data comprises:
associating a color with each of the vertices of the next based on the color data.

4. The computing device of claim 1, wherein re-generating the representation based on the data comprises:
repositioning at least some of the vertices of the mesh based on the data.

5. The computing device of claim 1, wherein re-generating the representation based on the data comprises:
determining a weight vector for each bone of the set of bones.

6. The computing device of claim 1, wherein the representation is re-generated using least squares or alternating minimization.

7. A computer readable memory device storing instructions executable by one or more processors to perform acts comprising:
generating a first representation of an object in a first pose, the first representation comprising a mesh and a set of bones, each bone from the set of bones attached to a vertex of a polygon of the mesh;
receiving data from a camera, the data comprising depth information for each pixel in the data;
determining each pixel in the data that corresponds to the vertex of a subset of the polygons; and
generating a second representation based on the data.

8. The computer readable memory device of claim 7, the acts further comprising:
receiving second data from the camera;
determining the vertices of the mesh that correspond to second pixels in the second data; and
generating a third representation based on the second data.

9. The computer readable memory device of claim 8, wherein:
the second data includes a second pose of the object; and
generating the third representation includes positioning the representation to correspond to the second pose of the object.

10. The computer readable memory device of claim 9, wherein generating the third representation comprises:
determining a coordinate transform to apply to the set of bones to position the first representation to correspond to the second pose of the object;
determining a vector of weights for each vertex of the subset of the polygons based on the coordinate transform; and
applying the coordinate transform and the vector of weights to the set of bones in the first representation to position the first representation to correspond to the second pose of the object.

11. The computer readable memory device of claim 7, wherein each polygon of the mesh of polygons has an associated color and texture.

12. The computer readable memory device of claim 7, wherein generating the second representation based on the data comprises:
determining occluded portions of the object based on the data;
selecting a generic model based on a type of the object; and
generating extrapolated portions corresponding to the occluded portions based on the data and the type of the object.

13. A method comprising:
under control of one or more processors configured with instructions to perform acts comprising:
receiving, from a camera, data associated with an object that is within a view of the camera;
determining occluded portions of the object that are occluded from the view of the camera;
determining extrapolated data corresponding to the occluded portions of the object; and
generating a representation corresponding to the object based on the data, the representation comprising a mesh and a set of bones, each bone of the set of bones attached to a vertex of a polygon of the mesh, the representation including the extrapolated data.

14. The method of claim 13, the acts further comprising:
receiving second data from the camera;
determining that the second data includes at least a first portion of the occluded portions of the object; and
generating the representation based on the second data.

15. The method of claim 14, the acts further comprising:
receiving third data from the camera;
determining that the third data includes at least a second portion of the occluded portions of the object; and
generating the representation based on the third data.

16. The method of claim 14, wherein:
the representation that is generated based on the second data more accurately characterizes the object as compared to the representation that is generated based on the data.

17. The method of claim 13, wherein:
the data from the camera comprises a plurality of pixels, and
the data further comprises color data and depth data for each of the plurality of pixels.

18. The method of claim 13, the acts further comprising:
generating a virtual world that includes the representation.

19. The method of claim 18, the acts further comprising:
receiving navigation input from one or more navigation controls; and
navigating the virtual world based on the navigation input.

20. The method of claim 13, the acts further comprising:
displaying a view of the representation that includes a portion of the representation that is not viewable from the camera.
